(19) United States
(12) Patent Application Publication
(10) Pub. No.: US 2025/0263030 A1
(43) Pub. Date: Aug. 21, 2025

(54) WIRE HARNESS

(71) Applicant: yazaki Corporation, Tokyo (JP)

(72) Inventors: Kazuomi KIYOSUE, Shizuoka (JP); Akinori NAKASHIMA, Shizuoka (JP); Takeshi ISHIKAWA, Shizuoka (JP); Daiki ITO, Shizuoka (JP); Dai ARAI, Shizuoka (JP)

(73) Assignee: yazaki Corporation, Tokyo (JP)

(21) Appl. No.: 19/021,971

(22) Filed: Jan. 15, 2025

(30) Foreign Application Priority Data
Feb. 15, 2024 (JP) 2024-020748

(51) Int. Cl. B60R 16/02

(52) U.S. Cl. CPC B60R 16/0215

(57) ABSTRACT

A wire harness includes a plurality of electric wires, and a resin member that has one main body covering the plurality of electric wires and is integrally molded with the plurality of electric wires; in which a cross-sectional shape of the main body in a plane orthogonal to an axial direction of the electric wire is a flat shape having a longitudinal direction and a lateral direction, and the main body has at least one of a first plane that is a plane extending in the longitudinal direction and a second plane that is a plane extending in the lateral direction.

### CROSS-REFERENCE TO RELATED APPLICATION(S)

The present application claims priority to and incorporates by reference the entire contents of Japanese Patent Application No. 2024-020748 filed in Japan on Feb. 15, 2024.

### BACKGROUND OF THE INVENTION

### 1. Field of the Invention

The present invention relates to a wire harness.

### 2. Description of the Related Art

Conventionally, there is a wire harness. Japanese Patent Application Laid-open No. 2023-066801 discloses a wire harness including a wire harness main body having an electric wire member and an exterior member surrounding an outer periphery of the electric wire member, a path regulating member attached to the outer periphery of the exterior member and configured to regulate a path of the wire harness main body, and an attachment member attached to an outer periphery of a part of the path regulating member in a length direction.

It is desired to be able to thin a routing space of a wire harness when the wire harness is routed. When an electric wire is inserted into a cylindrical exterior member, since the cross-sectional shape of the exterior member is circular, it is difficult to thin the routing space.

### SUMMARY OF THE INVENTION

An object of the present invention is to provide a wire harness capable of thinning a routing space.

In order to achieve the above mentioned object, a wire harness according to one aspect of the present invention includes a plurality of electric wires; and a resin member that has one main body covering the plurality of electric wires and is integrally molded with the plurality of electric wires, wherein a cross-sectional shape of the main body in a plane orthogonal to an axial direction of the electric wire is a flat shape having a longitudinal direction and a lateral direction, and the main body has at least one of a first plane that is a plane extending in the longitudinal direction and a second plane that is a plane extending in the lateral direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view of a wire harness according to an embodiment;

FIG. 2 is a cross-sectional view of a resin member according to the embodiment;

FIG. 3 is a cross-sectional view of a routed resin member;

FIG. 4 is a cross-sectional view of the routed resin member;

FIG. 5 is a side view of the routed resin member;

FIG. 6 is a cross-sectional view of a groove portion and the resin member;

FIG. 7 is a plan view of the routed resin member;

FIG. 8 is a cross-sectional view of the groove portion and the resin member;

FIG. 9 is a plan view of the routed resin member;

FIG. 10 is a perspective view of the routed resin member;

FIG. 11 is a plan view of a wire harness according to the embodiment;

FIG. 12 is a plan view of a wire harness according to the embodiment;

FIG. 13 is a cross-sectional view of the groove portion and the resin member;

FIG. 14 is a cross-sectional view of the groove portion and the resin member;

FIG. 15 is a plan view of the wire harness according to the embodiment; and

FIG. 16 is a cross-sectional view of the resin member according to the embodiment.

### DETAILED DESCRIPTION OF THE PREFERRED EMBODIMENT

Hereinafter, a wire harness according to an embodiment of the present invention will be described in detail with reference to the drawings. Note that the present invention is not limited by the embodiment. In addition, constituent elements in the following embodiment include those that can be easily assumed by those skilled in the art or those that are substantially the same.

### Embodiment

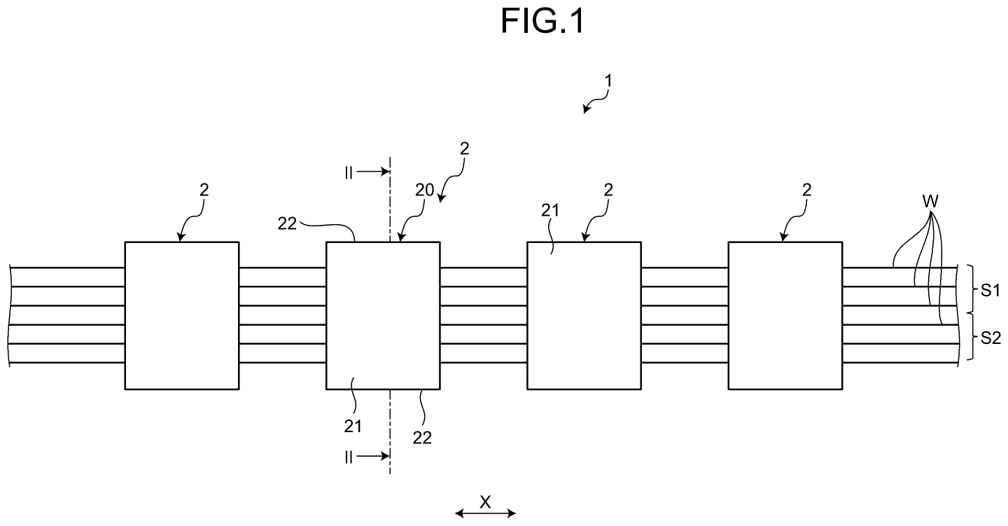

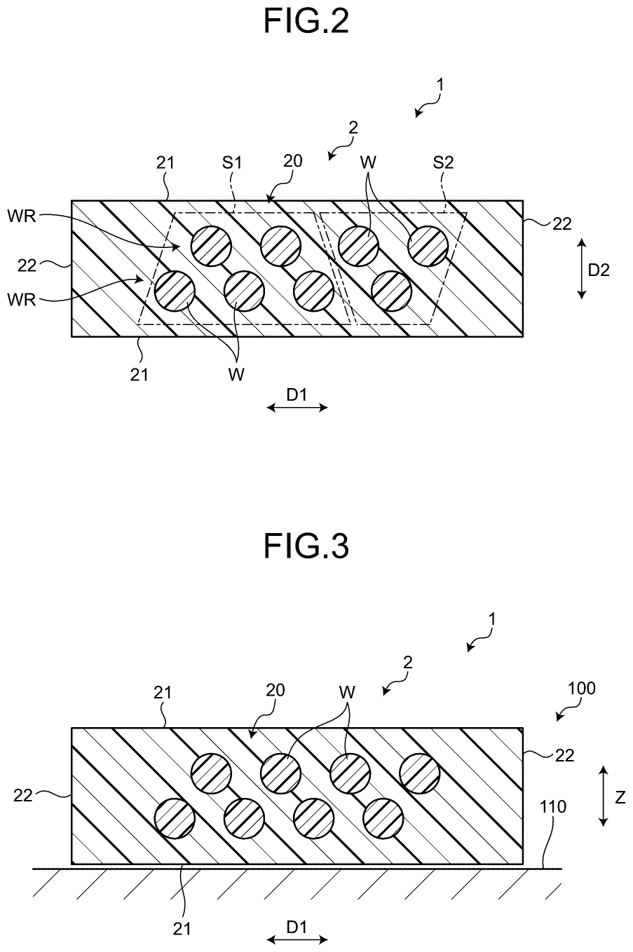

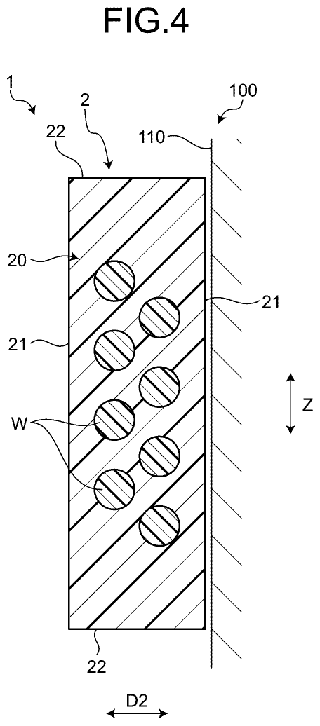

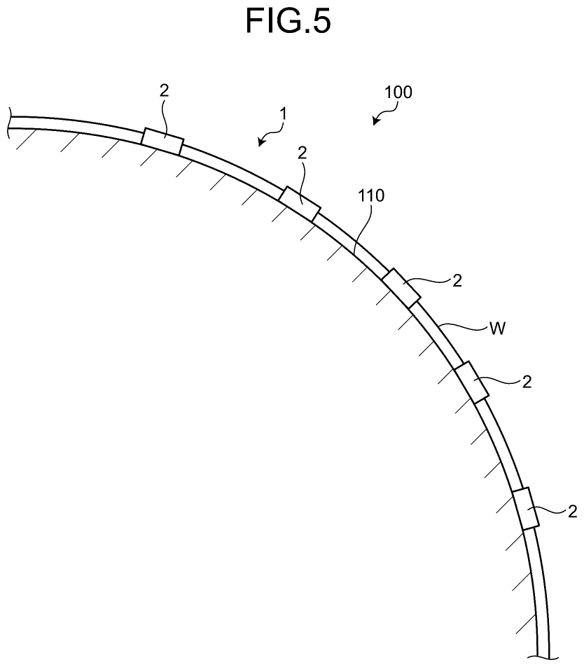

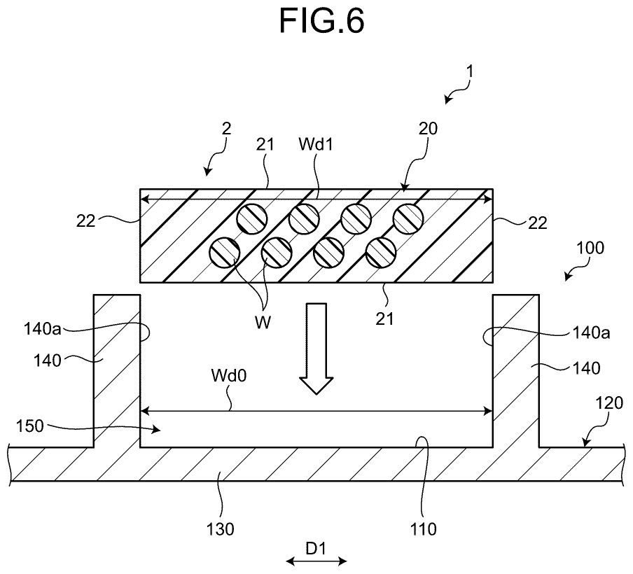

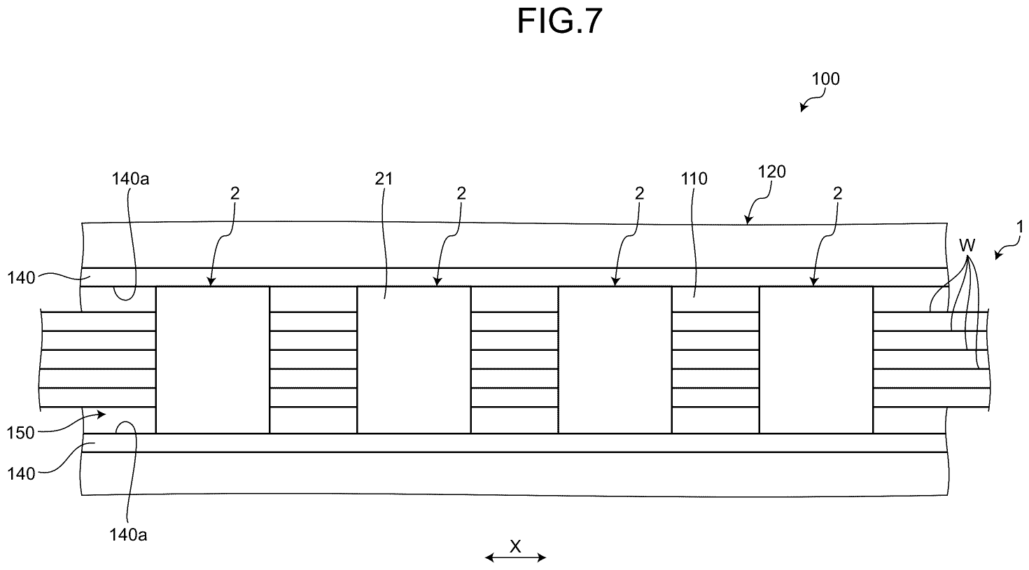

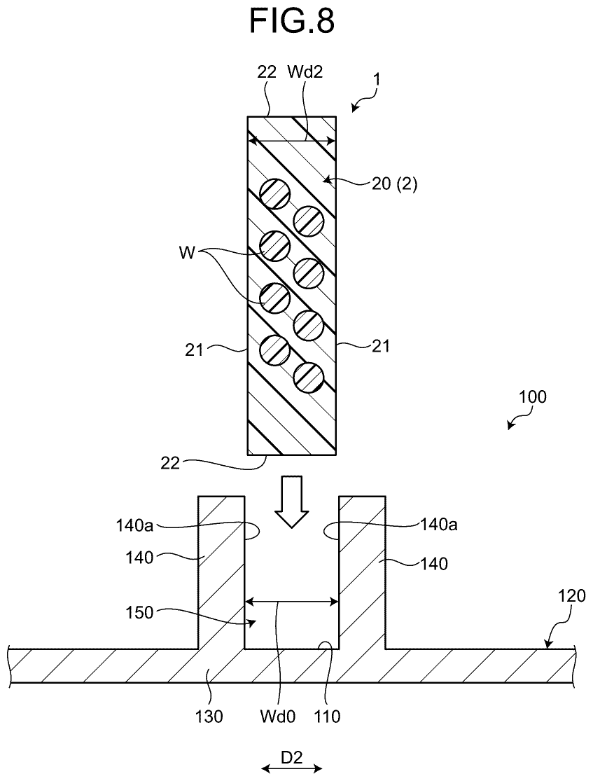

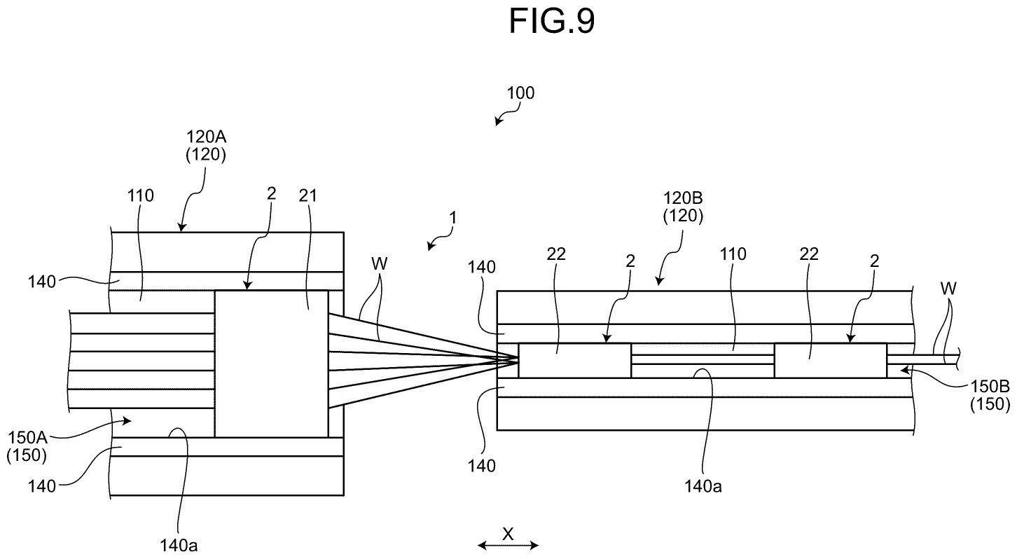

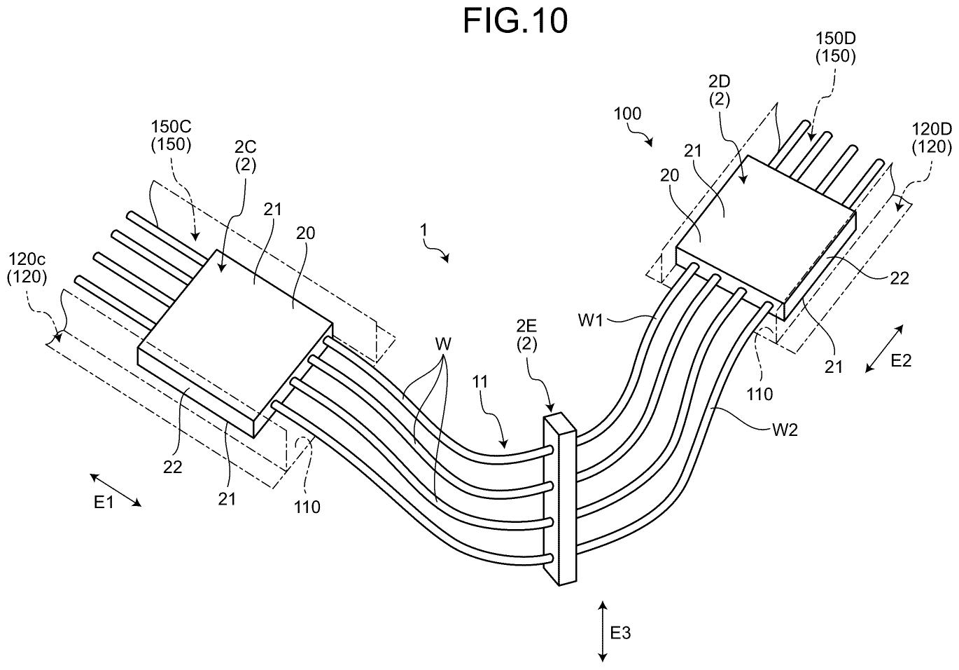

An embodiment will be described with reference to FIGS. 1 to 16. The present embodiment relates to a wire harness. FIG. 1 is a plan view of a wire harness according to an embodiment, FIG. 2 is a cross-sectional view of a resin member according to the embodiment, FIGS. 3 and 4 are cross-sectional views of a routed resin member, FIG. 5 is a side view of the routed resin member, FIG. 6 is a cross-sectional view of a groove portion and the resin member, FIG. 7 is a plan view of the routed resin member, FIG. 8 is a cross-sectional view of the groove portion and the resin member, FIG. 9 is a plan view of the routed resin member, and FIG. 10 is a perspective view of the routed resin member.

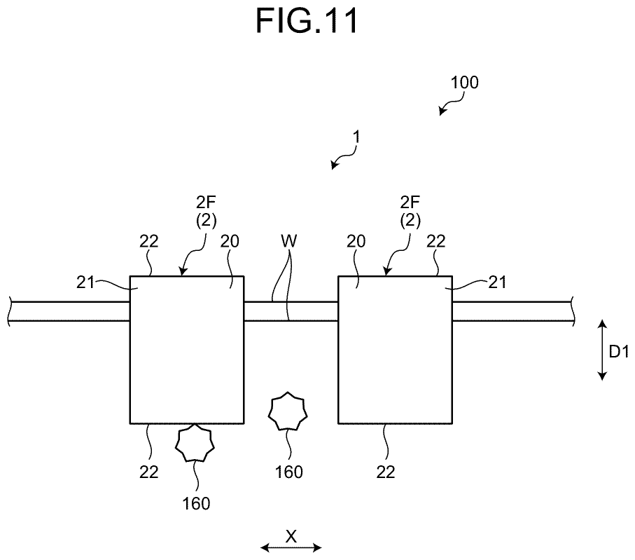

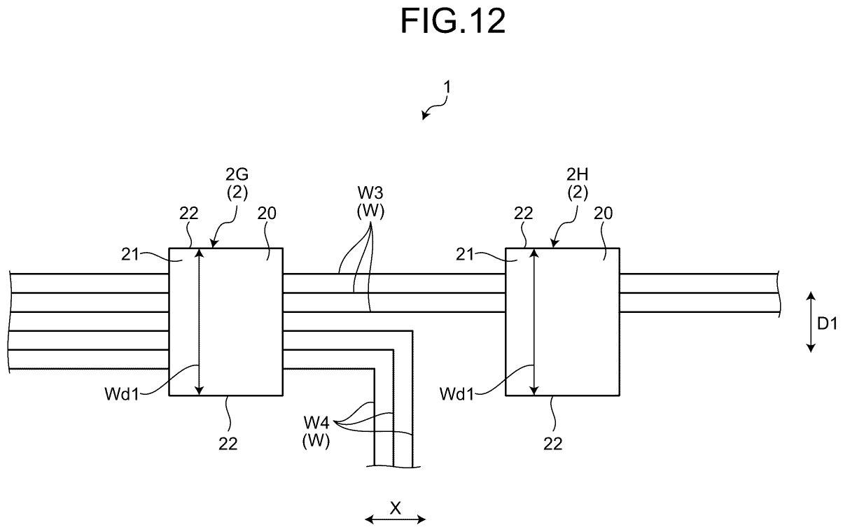

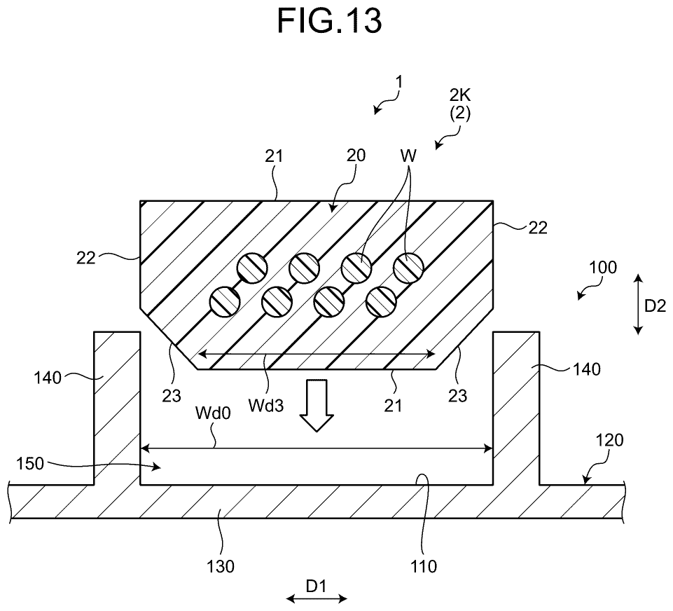

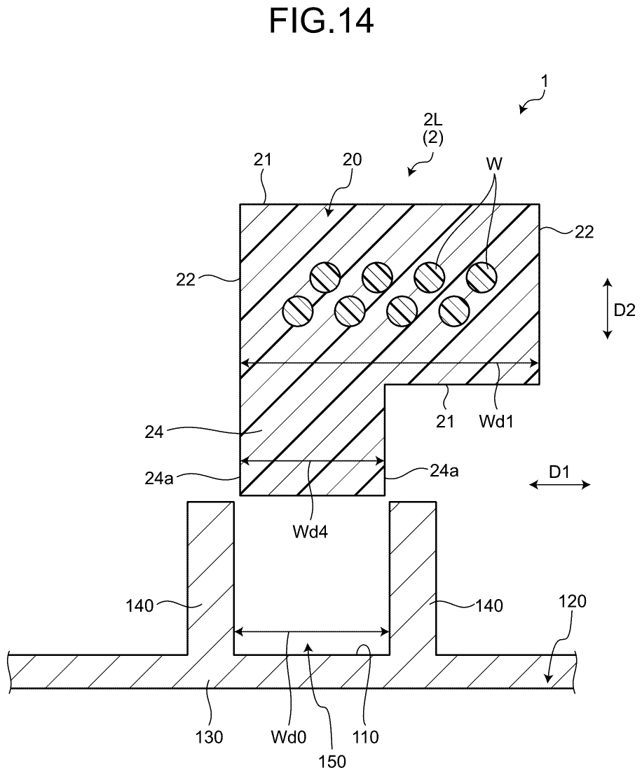

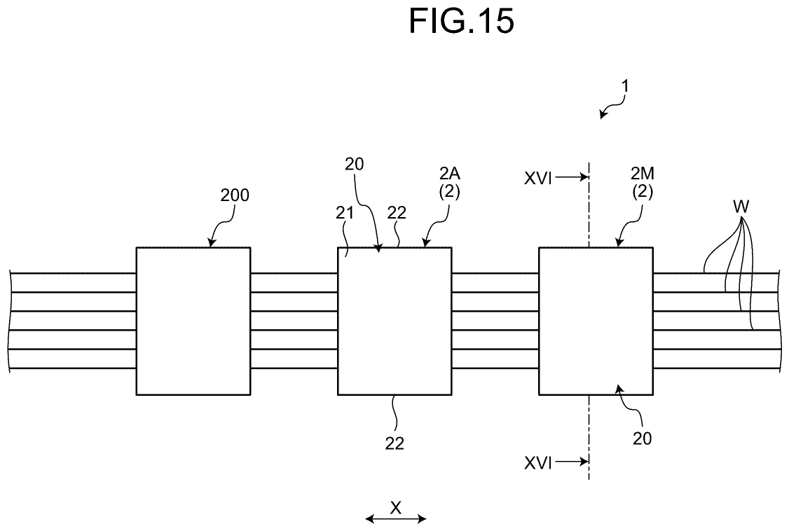

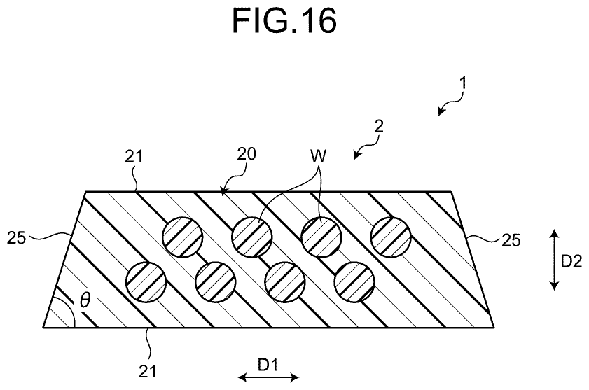

FIGS. 11 and 12 are plan views of the wire harness according to the embodiment, FIGS. 13 and 14 are cross-sectional views of the groove portion and the resin member, FIG. 15 is a plan view of the wire harness according to the embodiment, and FIG. 16 is a cross-sectional view of the resin member according to the embodiment. FIG. 2 illustrates a cross-section taken along line II-II in FIG. 1. FIG. 16 illustrates a cross-section taken along line XVI-XVI in FIG. 15.

A wire harness 1 of the present embodiment includes a plurality of electric wires W and at least one resin member 2. In the present specification, the axial direction of the electric wire W is simply referred to as an axial direction X. The wire harness 1 of FIG. 1 includes a plurality of resin members 2. The plurality of resin members 2 are arranged side by side along the axial direction X. The plurality of resin members 2 are disposed at intervals. That is, the plurality of electric wires W are exposed between adjacent two of the resin members 2. Each electric wire W includes a core wire and an insulating sheath.

In the illustrated wire harness 1, the plurality of electric wires W are configured by bundling a plurality of sub harnesses. The wire harness 1 includes a first sub harness S1 and a second sub harness S2. That is, the plurality of electric wires W include the electric wire W of the first sub harness S1 and the electric wire W of the second sub harness S2.

The resin member 2 is a member integrally molded with respect to the plurality of electric wires W. The resin member 2 is formed so as to cover the sheath of the electric wire W. The resin member 2 is molded using, for example, an insulating synthetic resin. The resin member 2 is, for example, insert-molded with respect to the plurality of electric wires W. The resin member 2 of the present embodiment is elastically deformable. The resin member 2 may be a member having flexibility such as rubber.

FIG. 2 illustrates a cross-sectional shape of the resin member 2 in a plane orthogonal to the axial direction X. As illustrated in FIG. 2, the resin member 2 has one main body 20 that covers the plurality of electric wires W. The cross-sectional shape of the main body 20 is a flat shape having a longitudinal direction D1 and a lateral direction D2. The longitudinal direction D1 and the lateral direction D2 are, for example, orthogonal to each other.

The main body 20 of the resin member 2 has at least one plane of a first plane 21 and a second plane 22. The first plane 21 is a plane along the longitudinal direction D1. The second plane 22 is a plane along the lateral direction D2.

The cross-sectional shape of the main body 20 illustrated in FIG. 2 is rectangular. That is, the main body 20 in FIG. 2 has a pair of first planes 21 and a pair of second planes 22. When the cross-sectional shape of the main body 20 is rectangular, the first plane 21 is orthogonal to the lateral direction D2. The two first planes 21 are parallel. The second plane 22 is orthogonal to the longitudinal direction D1. The two second planes 22 are parallel.

The main body 20 is formed so as to surround the plurality of electric wires W. In other words, in the cross-section orthogonal to the axial direction X, the plurality of electric wires W are located inside a region surrounded by the first planes 21 and the second planes 22.

The plurality of electric wires W are disposed along the longitudinal direction D1 inside the main body 20. In the resin member 2 of FIG. 2, the plurality of electric wires W have two rows WR of the electric wires W disposed in the longitudinal direction D1. A first sub harness S1 and a second sub harness S2 are arranged side by side, for example, in the longitudinal direction D1. In this case, the electric wire W of the first sub harness S1 and the electric wire W of the second sub harness S2 are disposed in the longitudinal direction D1. Note that the electric wire W of the first sub harness S1 may constitute one row WR, and the electric wire W of the second sub harness S2 may constitute another row WR. The wire harness 1 may have three or more sub harnesses.

The wire harness 1 is routed such that, for example, one first plane 21 faces a routing surface 110 of a vehicle 100. FIG. 3 illustrates the wire harness 1 routed on the routing surface 110. The routing surface 110 is, for example, a surface of a metal member configuring a body of the vehicle 100. The routing surface 110 may be a surface of a locker portion of the vehicle 100. The routing surface 110 may be an upper surface in a vehicle up-down direction Z.

Since the first plane 21 along the longitudinal direction D1 faces the routing surface 110, the thinning of the routing space for when the wire harness 1 is routed is realized. When the routing surface 110 is a surface facing the upper side in the vehicle up-down direction Z, it is possible to thin the routing space in the vehicle up-down direction Z.

Note that as illustrated in FIG. 4, the routing surface 110 may be a surface along the vehicle up-down direction Z. The routing surface 110 may be a surface facing the vehicle width direction. In this case, it becomes possible to thin the routing space in the vehicle width direction. The routing surface 110 may be a surface facing the vehicle front-back direction. In this case, it becomes possible to thin the routing space in the vehicle front-back direction.

The direction in which the wire harness 1 extends may be the vehicle up-down direction Z, the vehicle front-back direction, the vehicle width direction, or other directions. The wire harness 1 may be linearly routed or may be routed so as to have a bent portion. The routing surface 110 is not limited to a plane.

The routing surface 110 may be, for example, a surface curved in an arc shape. FIG. 5 illustrates the routing surface 110 curved in an arc shape along the extending direction of the wire harness 1. The routing surface 110 in FIG. 5 is, for example, a surface of a wheel house of the vehicle 100. In the wire harness 1 of FIG. 5, the electric wire W is exposed between adjacent two of the resin members 2. Therefore, the exposed electric wire W can be easily deformed along the routing surface 110 extending while being curved. Furthermore, the resin member 2 can be elastically deformed along the shape of the routing surface 110.

The wire harness 1 may be routed in a groove portion provided in the vehicle 100. FIG. 6 illustrates a member 120 having the routing surface 110. The member 120 is, for example, a metal member and configures a body of the vehicle 100. The member 120 is manufactured by, for example, die casting or extrusion molding.

The member 120 includes a plate portion 130 and a pair of ribs 140. The plate portion 130 is formed in a plate shape and has a routing surface 110. The pair of ribs 140 are raised from the plate portion 130 and faces each other. The rib 140 protrudes out from the plate portion 130 in a direction orthogonal to the routing surface 110. The rib 140 has a holding surface 140a. The illustrated holding surface 140a is a plane. The two holding surfaces 140a are, for example, parallel.

The member 120 has a groove portion 150 surrounded by the pair of ribs 140 and the plate portion 130. The cross-sectional shape of the groove portion 150 in a plane orthogonal to a routing path of the wire harness 1 is, for example, rectangular. The main body 20 of the resin member 2 is inserted into the groove portion 150.

For example, the resin member 2 is inserted into the groove portion 150 with the first plane 21 facing the routing surface 110. The value of the width Wd1 of the first plane 21 is the same as the value of the width Wd0 of the groove portion 150 or slightly larger than the value of the width Wd0 of the groove portion 150. Therefore, the holding surfaces 140a can come into contact with the second planes 22 of the main body 20 to sandwich the main body 20. An operator who routes the wire harness 1 routes the wire harness 1 along the groove portion 150 while pushing the main body 20 of the resin member 2 into the groove portion 150.

FIG. 7 illustrates the wire harness 1 routed in the groove portion 150. When the wire harness 1 has the plurality of resin members 2, each of the plurality of resin members 2 is pushed into the groove portion 150. The wire harness 1 may be routed such that the entire resin member 2 is accommodated in the groove portion 150. In other words, the wire harness 1 may be routed such that the two first planes 21 of the resin member 2 are accommodated between the holding surfaces 140a.

As illustrated in FIG. 8, in the resin member 2, the second plane 22 of the main body 20 may face the routing surface 110. In this case, the main body 20 of the resin member 2 is held by the two holding surfaces 140a of the member 120 from both sides in the lateral direction D2. The value of the width Wd2 of the second plane 22 is the same as the value of the width Wd0 of the groove portion 150 or slightly larger than the value of the width Wd0 of the groove portion 150. Therefore, the holding surfaces 140a can come into contact with the first planes 21 of the main body 20 to sandwich the main body 20.

In the routed wire harness 1, the postures of the plurality of resin members 2 may be different. FIG. 9 illustrates the wire harness 1 in which the plurality of resin members 2 are accommodated in the groove portion 150 in different postures. The vehicle 100 of FIG. 9 has two members 120. One of the two members 120 is referred to as a first member 120A, and the other member 120 is referred to as a second member 120B. The two members 120A and 120B may be disposed continuously or may be disposed at intervals.

The first member 120A and the second member 120B have a routing surface 110 and a groove portion 150, respectively. A first groove portion 150A which is the groove portion 150 of the first member 120A has a wider width Wd0 than a second groove portion 150B which is the groove portion 150 of the second member 120B.

The wire harness 1 is routed such that the first plane 21 faces the routing surface 110 of the first member 120A and the second plane 22 faces the routing surface 110 of the second member 120B. In the first member 120A, the plurality of electric wires W are mainly arranged in the width direction of the first groove portion 150A. In the second member 120B, the plurality of electric wires W are mainly arranged in the depth direction of the second groove portion 150B. The plurality of electric wires W change the arrangement direction between the first member 120A and the second member 120B. The plurality of electric wires W are routed so as to be twisted in a spiral shape in a space between the first groove portion 150A and the second groove portion 150B. Note that the first groove portion 150A and the second groove portion 150B may be the groove portions 150 provided in the same member 120.

The wire harness 1 may be routed along a bent path or a curved path. FIG. 10 illustrates the wire harness 1 routed while being curved between two groove portions 150C and 150D. The routing path of the wire harness 1 includes a third groove portion 150C and a fourth groove portion 150D. The third groove portion 150C is a groove portion 150 of a third member 120C and extends in a first direction E1. The fourth groove portion 150D is a groove portion 150 of a fourth member 120D and extends in a second direction E2. The second direction E2 intersects with the first direction E1, and is, for example, orthogonal to the first direction E1.

The plurality of resin members 2 included in the wire harness 1 include resin members 2C, 2D, and 2E. The cross-sectional shapes of the resin members 2C, 2D, and 2E are, for example, rectangular. In each of the resin members 2C, 2D, and 2E, the plurality of electric wires W are arranged side by side in the longitudinal direction D1.

The resin member 2C is disposed in the third groove portion 150C and held by the third groove portion 150C. The resin member 2D is disposed in the fourth groove portion 150D and held by the fourth groove portion 150D. The resin member 2E is disposed between the two resin members 2C and 2D. The resin member 2C is inserted into the third groove portion 150C such that the plurality of electric wires W are arranged in the width direction of the third groove portion 150C. The resin member 2D is inserted into the fourth groove portion 150D such that the plurality of electric wires W are arranged in the width direction of the fourth groove portion 150D. That is, the two resin members 2C and 2D are disposed with the first plane 21 facing the routing surface 110.

The exemplified resin member 2E is disposed in a curved portion 11 of the wire harness 1. The curved portion 11 is a portion where the extending direction of the wire harness 1 changes from the first direction E1 to the second direction E2, and is routed while curving the electric wire W. The resin member 2E is disposed, for example, at an intermediate portion of a portion where the electric wire W is curved.

The resin member 2E is disposed such that the plurality of electric wires W are arranged in a third direction E3 inside the resin member 2E. The third direction E3 is a direction orthogonal to both the first direction E1 and the second direction E2. The plurality of electric wires W include an inner electric wire W1 and an outer electric wire W2. The inner electric wire W1 is an electric wire W located on the innermost side in the curved portion 11. That is, the inner electric wire W1 is the electric wire W extending on the innermost peripheral side in the curved portion 11 among the plurality of electric wires W. The outer electric wire W2 is an electric wire W located on the outermost side in the curved portion 11.

The resin member 2E is disposed so as to lift the electric wire W1 on the inner side with respect to the third groove portion 150C and the fourth groove portion 150D. In the resin member 2E of FIG. 10, the outer electric wire W2 is positioned at the same position as the two resin members 2C and 2D in the third direction E3. In addition, the resin member 2E positions the inner electric wire W1 at a position away from the two resin members 2C and 2D in the third direction E3. The other electric wires W are arranged in order in the third direction E3 from the outer electric wire W2 to the inner electric wire W1.

The resin member 2E may be held by the third member 120C, may be held by the fourth member 120D, or may be held by another member 120. The resin member 2E may be disposed in the posture illustrated in FIG. 10 using the reaction force generated in the electric wire W.

The resin member 2E can reduce the peripheral length difference generated in the plurality of electric wires W by disposing the plurality of electric wires W in the third direction E3. In other words, the resin member 2E can absorb the extra length generated in the inner electric wire W1 at the curved portion 11 using the space in the third direction E3.

The plurality of electric wires W may not be disposed uniformly inside the main body 20 of the resin member 2. For example, the positions of the plurality of electric wires W may be positions close to one side in the longitudinal direction D1 or the lateral direction D2. FIG. 11 illustrates the resin member 2F in which the plurality of electric wires W are disposed to be close to one side in the longitudinal direction D1. The wire harness 1 having such a resin member 2F may be used so as to avoid interference of a peripheral component 160 with the electric wire W.

In a case where the peripheral component 160 is located in the routing path of the wire harness 1 or in the vicinity of the routing path, the interference of the peripheral component 160 with the electric wire W is desirably suppressed in advance. In this case, the resin member 2F is disposed in the routing path so that the distance between the peripheral component 160 and the plurality of electric wires W can be appropriately secured. In the wire harness 1, all the resin members 2 may be the resin member 2F that holds the electric wire W in a manner shifted to one side, or some of the resin members 2 may be the resin member 2F that holds the electric wire W in a manner shifted to one side.

Among the plurality of electric wires W, some electric wires W may be drawn out as branch wires from between the two resin members 2. The wire harness 1 illustrated in FIG. 12 includes adjacent two resin members 2G and 2H. Among the plurality of electric wires W, some electric wires W3 are held by both of the two resin members 2G and 2H. Some of the other electric wires W4 are drawn out as branch wires from between the two resin members 2G and 2H. The electric wire W4 is held by one resin member 2G and is not held by the other resin member 2H. The electric wire W4, which is a branch wire, is connected to, for example, a connector or the like.

For example, the resin members 2G and 2H are inserted into the groove portion 150 with the first plane 21 facing the routing surface 110. In this case, the second plane 22 of the main body 20 is held by the holding surface 140a. In this case, the width Wd1 of the first plane 21 of one resin member 2G may be equal to the width Wd1 of the first plane 21 of the other resin member 2H. For example, when the two resin members 2G and 2H are inserted into the groove portion 150 having a constant width Wd0, the widths Wd1 of the two resin members 2G and 2H are preferably equal to each other. In this case, regardless of the number of electric wires W to be held, the two resin members 2G and 2H are molded with the same width Wd1.

The resin members 2G and 2H may be inserted into the groove portion 150 with the second plane 22 facing the routing surface 110. In this case, the width Wd2 of the second plane 22 of one resin member 2G may be equal to the width Wd2 of the second plane 22 of the other resin member 2H. The two resin members 2G and 2H between which the branch portion of the electric wire W is placed may have the same cross-sectional shape. That is, the two resin members 2G and 2H may have the width Wd1 of the same value and the width Wd2 of the same value. By making the cross-sectional shape of the resin member 2 common regardless of the number of electric wires W to be held, it is possible to make the molding die common.

The main body 20 of the resin member 2 may be provided with a chamfered portion. FIG. 13 illustrates a resin member 2K having a chamfered portion 23. The main body 20 of the resin member 2K has a chamfered portion 23. The chamfered portion 23 in FIG. 13 is provided at corner portions on both sides sandwiching one first plane 21. In other words, in the main body 20, the corner portions on both sides sandwiching one first plane 21 have a chamfered shape.

In the resin member 2K having the chamfered portion 23, the rigidity of the end portion having the chamfered portion 23 is smaller than the rigidity of the central portion. For this reason, the reaction force of the resin member 2K when the resin member 2K is inserted into the groove portion 150 is reduced, and the workability of the insertion work is improved. The illustrated chamfered portion 23 is formed such that the main body 20 can be guided between the pair of ribs 140.

The chamfered portion 23 is an inclined surface inclined with respect to the longitudinal direction D1. The chamfered portion 23 is inclined toward the center in the longitudinal direction D1 from the second plane 22 toward the first plane 21 along the lateral direction D2. The width Wd3 of the first plane 21 sandwiched by the chamfered portion 23 is preferably shorter than the width Wd0 of the groove portion 150. Note that the chamfered portions 23 may be provided at corner portions on both sides sandwiching the second plane 22.

The resin member 2 may have a protrusion to be inserted into the groove portion 150. FIG. 14 illustrates a resin member 2L having a protrusion 24. The protrusion 24 protrudes from one first plane 21 of the main body 20. The cross-sectional shape of the illustrated protrusion 24 is rectangular. The protrusion 24 protrudes from the first plane 21 in the lateral direction D2. The protrusion 24 protrudes, for example, from an end portion in the longitudinal direction D1 in the first plane 21. The protrusion 24 has two parallel surfaces 24a along the protruding direction of the protrusion 24. The illustrated two surfaces 24a are parallel to the lateral direction D2. One surface 24a is continuous with the second plane 22. The value of the width Wd4 of the protrusion 24 is the same as the value of the width Wd0 of the groove portion 150 or slightly larger than the value of the width Wd0 of the groove portion 150.

The wire harness 1 having the resin member 2L is routed while inserting the protrusion 24 of the resin member 2L into the groove portion 150. The protrusion 24 is sandwiched and held by the pair of ribs 140. The main body 20 is routed outside the groove portion 150 along the extending direction of the groove portion 150.

The main body 20 of the resin member 2L has a longitudinal direction D1 and a lateral direction D2. As illustrated in FIG. 14, the resin member 2L is fixed to the groove portion 150 with one first plane 21 facing the routing surface 110.

The width Wd1 of the main body 20 of the resin member 2 is determined according to the number of the electric wires W held by the main body 20 and the diameter of the electric wire W. On the other hand, the value of the width Wd0 of the groove portion 150 is determined by design requirements or the like on the vehicle 100 side. The resin member 2L can be fixed to the member 120 even when the width Wd0 of the groove portion 150 is small with respect to the width Wd1 of the main body 20.

In addition, according to the resin member 2L having the protrusion 24, it is possible to thin the routing space in the depth direction of the groove portion 150. For example, when attempting to insert the main body 20 into the groove portion 150, it is inserted into the groove portion 150 with the second plane 22 facing the routing surface 110. In this case, the width Wd2 of the main body 20 in the lateral direction D2 is determined according to the width Wd0 of the groove portion 150. In addition, the width Wd1 in the longitudinal direction D1 is determined according to the width Wd2. As a result, the dimension of the resin member 2 in the depth direction of the groove portion 150 may increase. On the other hand, in the resin member 2L having the protrusion 24, the widths Wd1 and Wd2 of the main body 20 can be determined without being restricted by the width Wd0 of the groove portion 150.

The wire harness 1 may include a plurality of resin members having different cross-sectional shapes. The wire harness 1 illustrated in FIG. 15 includes three types of resin members 2A, 2M, and 200 having different cross-sectional shapes from each other.

The resin members 2A and 2M are the resin member 2 according to the present embodiment. The main body 20 of the resin member 2A has a rectangular cross-sectional shape illustrated in FIG. 2. As illustrated in FIG. 16, the main body 20 of the resin member 2M has a trapezoidal cross-sectional shape. The main body 20 has a longitudinal direction D1 and a lateral direction D2. The main body 20 of the resin member 2M has two first planes 21 and two side surfaces 25.

The two first planes 21 correspond to bases of a trapezoid. In the exemplified resin member 2M, the direction of the base is the longitudinal direction D1. The two side surfaces 25 correspond to oblique sides of the trapezoid. The two side surfaces 25 may have the same inclination angle θ with respect to the first plane 21, or may have inclination angles θ different from each other.

The resin member 200 has a circular column shape along the axial direction X. That is, the shape of the resin member 200 in a plane orthogonal to the axial direction X is circular. The cross-sectional shape of the resin member 200 may be an ellipse. The shape of the resin members 2A, 2M, and 200 is selected according to the cross-sectional shape of the path at each position of the routing path.

As described above, the wire harness 1 of the present embodiment includes the plurality of electric wires W and the resin member 2. The resin member 2 has one main body 20 covering the plurality of electric wires W, and is a member integrally molded with respect to the plurality of electric wires W. A cross-sectional shape of the main body 20 in a plane orthogonal to the axial direction X of the electric wire W is a flat shape having the longitudinal direction D1 and the lateral direction D2. The main body 20 has at least one of a first plane 21 that is a plane extending in the longitudinal direction D1 and a second plane 22 that is a plane extending in the lateral direction D2.

When the main body 20 has the first plane 21, the wire harness 1 can be routed with the first plane 21 of the main body 20 facing the routing surface 110. As a result, the routing space of the wire harness 1 in the direction orthogonal to the routing surface 110 can be thinned. When the main body 20 has the second plane 22, the wire harness 1 can be routed with the second plane 22 of the main body 20 facing the routing surface 110. As a result, the routing space of the wire harness 1 in the direction along the routing surface 110 can be thinned. Therefore, according to the wire harness 1 of the present embodiment, the thinning of the routing space is realized.

The resin member 2 has a function as an exterior member that protects the plurality of electric wires W. When the resin member 2 is assembled to the groove portion 150 or the like, the resin member 2 functions as a fixing member that fixes the plurality of electric wires W to the routing surface 110. Furthermore, the resin member 2 functions as a bundling member that bundles the plurality of electric wires W.

The cross-sectional shape of the main body 20 is, for example, rectangular. The plurality of electric wires W may be arranged along the longitudinal direction D1 inside the main body 20. It is possible to thin the resin member 2 by arranging the plurality of electric wires W along the longitudinal direction D1.

In the main body 20, corner portions on both sides sandwiching one plane may have a chamfered shape. The main body 20 having a chamfered shape can facilitate insertion work of the main body 20 into the groove portion 150.

The resin member 2 may have a protrusion 24 protruding from one plane of the main body 20. For example, the protrusion 24 has two parallel surfaces 24a along the protruding direction of the protrusion 24. According to the resin member 2 having the protrusion 24, the dimension of the main body 20 can be set without being restricted by the width Wd0 of the groove portion 150.

The wire harness 1 includes, for example, a plurality of resin members 2. In this case, the plurality of electric wires W are exposed between adjacent two of the resin members 2. The wire harness 1 in which the electric wire W is exposed between the two resin members 2 can be easily deformed according to the routing path.

Some electric wires W4 among the plurality of electric wires W may be drawn out as branch wires from between the adjacent two resin members 2G and 2H. Since the electric wires W on both sides of the branch portion are held by the resin member 2, the shape of the wire harness 1 is easily stabilized.

The cross-sectional shapes of the plurality of resin members 2 in the plane orthogonal to the axial direction X of the electric wire W may be the same. As a result, the die for molding the resin member 2 is made common, whereby the cost can be reduced. For example, when some electric wires W4 are drawn out as branch wires from between the two resin members 2G and 2H, the cross-sectional shapes of the two resin members 2G and 2H may be the same.

The plurality of electric wires W may include the electric wire W of the first sub harness S1 and the electric wire W of the second sub harness S2. In this case, one resin member 2 is molded for both the first sub harness S1 and the second sub harness S2. The resin member 2 functions as a bundling member that gathers the two sub harnesses S1 and S2.

The number of resin members 2 included in the wire harness 1 may be one. For example, the wire harness 1 may have an elongated resin member 2 extending along the axial direction X of the electric wire W. In one resin member 2, the width Wd1 and the width Wd2 may be different depending on the position in the axial direction X. For example, when the width Wd0 of the groove portion 150 changes in the middle of the routing path, the main body 20 of the resin member 2 may have a wide-width portion and a narrow-width portion.

When the resin member 2 has the protrusions 24, one resin member 2 may have a plurality of protrusions 24. For example, one resin member 2 may have a plurality of protrusions 24 arranged in the extending direction of the groove portion 150.

The insertion target of the protrusion 24 may be a recess provided in the member 120. For example, the member 120 may have a plurality of recesses arranged at intervals along the routing path of the wire harness 1. In this case, the plurality of protrusions 24 may be inserted into the corresponding recesses.

When the main body 20 of the resin member 2 has two first planes 21, the two first planes 21 may not be parallel. For example, when the resin member 2 is disposed with the first plane 21 facing the routing surface 110, it is conceivable that there is a limitation on the routing space in a direction orthogonal to the routing surface 110. In this case, one first plane 21 may be inclined with respect to the other first plane 21. Similarly, when the main body 20 of the resin member 2 has two second planes 22, the two second planes 22 may not be parallel.

The target into which the resin member 2 is inserted is not limited to the groove portion 150 formed between the ribs 140. For example, a recess or a groove portion into which the resin member 2 can be inserted may be formed in the member 120. Furthermore, the resin member 2 can be inserted between two opposing surfaces. For example, the resin member 2 may be inserted into a gap provided between two members.

In the wire harness 1 disclosed in the above embodiment, the wire harness 1 can be fixed to the vehicle 100 by inserting the resin member 2 into the recess or the opposing surface. Since it is not necessary to perform drilling or thread cutting for fixing in the vehicle 100, the manufacturing cost on the vehicle side is reduced.

The contents disclosed in the above embodiment can be appropriately combined and executed.

In a wire harness according to the present embodiment, a main body of a resin member has at least one of a first plane that is a plane extending in a longitudinal direction and a second plane that is a plane extending in a lateral direction. According to the wire harness of the present embodiment, an effect is obtained in which a routing space can be thinned by making the first plane or the second plane face the routing surface.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a plurality of electric wires; and
a resin member that has one main body covering the plurality of electric wires and is integrally molded with the plurality of electric wires, wherein
a cross-sectional shape of the main body in a plane orthogonal to an axial direction of the electric wire is a flat shape having a longitudinal direction and a lateral direction, and
the main body has at least one of a first plane that is a plane extending in the longitudinal direction and a second plane that is a plane extending in the lateral direction.

2. The wire harness according to claim 1, wherein
the cross-sectional shape of the main body is rectangular, and
the plurality of electric wires are disposed along the longitudinal direction inside the main body.

3. The wire harness according to claim 1, wherein
in the main body, corner portions on both sides sandwiching one plane have a chamfered shape.

4. The wire harness according to claim 1, wherein
the resin member has a protrusion protruding from one plane of the main body, and
the protrusion has two parallel surfaces along a protruding direction of the protrusion.

5. The wire harness according to claim 1, comprising:
a plurality of the resin members, wherein
the plurality of electric wires are exposed between adjacent two of the resin members.

6. The wire harness according to claim 5, wherein
some electric wires of the plurality of electric wires are drawn out as branch wires from between the adjacent two of the resin members.

7. The wire harness according to claim 5, wherein
cross-sectional shapes of the plurality of the resin members in a plane orthogonal to the axial direction of the electric wire are the same.

8. The wire harness according to claim 1, wherein
the plurality of electric wires include an electric wire of a first sub harness and an electric wire of a second sub harness, and
one resin member is molded to both the first sub harness and the second sub harness.
